(19) United States
(12) Patent Application Publication
(10) Pub. No.: US 2024/0391349 A1
(43) Pub. Date: Nov. 28, 2024

(54) Minimum Cost Demand Charge Management By Electric Vehicles

(71) Applicant: NetZero V2G Tchnologies LLC., Fort Washington, PA (US)

(72) Inventor: Paul Harriman KYDD, Lawrenceville, NJ (US)

(21) Appl. No.: 18/795,087

(22) Filed: Aug. 5, 2024

Related U.S. Application Data
(63) Continuation of application No. 16/563,108, filed on Sep. 6, 2019, now Pat. No. 12,071,036.
Application No. 16/563,108 is a continuation-in-part of application No. 15/441,484, filed on Feb. 24, 2017, now Pat. No. 10,439,428.

(51) Int. Cl. B60L 55/00; B60L 3/00; B60L 53/60; H02J 7/00; H02J 9/00

(52) U.S. Cl. CPC B60L 55/00; B60L 3/0046; B60L 53/60; H02J 7/0029; H02J 9/002; H02J 2310/64

(57) ABSTRACT

This invention has as its objective provision of a method and apparatus to enable the batteries of Electric Vehicles (EV)s to level the electric demand in buildings to reduce demand charges based on instantaneous demand for electric power. This load leveling is done by connecting the EV to the building electrical system by its conventional Alternating Current (AC) recharging connection, and by an additional Direct Current (DC) path supporting intermittent loads. In this way the EV battery stands between the AC energy source and the intermittent load and reduces the electric power drawn from the grid to a constant minimum level, thereby minimizing demand charges.

### CROSS-REFERENCE TO RELATED APPLICATIONS

The present application is a continuation of U.S. patent application Ser. No. 16/563,108 filed on Sep. 6, 2019 which in turn is a continuation in part of U.S. patent application Ser. No. 15/441,484 filed on Feb. 24, 2017 now issued as U.S. Pat. No. 10,439,428 on Oct. 8, 2019 the disclosures of all of the foregoing are incorporated in the present application by reference in their entirety.

This application is related to U.S. patent application “Vehicle-Solar-Grid Integration” Ser. No. 14/101,423 filed Dec. 10, 2013, now issued as U.S. Pat. No. 9,566,867, Feb. 14, 2017, by the present inventor, and Provisional Patent Applications “Bidirectional Power Electronic Interface” No. 61/889,067, filed Oct. 10, 2013, “Bidirectional Power Electronic Interface with Sustaining Power” 61/921,583, filed Dec. 30, 2013, “Vehicle-Solar-Grid Integration with Supplementary Battery” 62/050,819, filed Sep. 16, 2014, “Low-Cost EVPV for Vehicle-Solar-Grid Integration”, 62/297,462, filed Feb. 19, 2016, “Minimum Cost EVPV for Vehicle-Solar-Grid Integration” 62/299,756, filed Feb. 25, 2016, later filed as nonprovisional patent application Ser. No. 15/441,484, Feb. 24, 2017, and Ser. No. 16/562,565, Sep. 3, 2019, “Vehicle-Solar-Grid Integration for Back up Power” 62/465,424 filed Mar. 1, 2017 now filed as non provisional patent application Ser. No. 16/044,683 and Application “Non Grid-tied Vehicle-Solar Uninterruptable Power System” 62/544,041, filed Aug. 11, 2017, now filed as patent application Ser. No. 16/055,035, and “Demand Charge Management by Electric Vehicles”, U.S. Pat. No. 62,721,216, filed Aug. 22, 2018 by the present inventor and “Multiple Load Micro-Grid Implementation of Vehicle-Solar-Grid Integration” 62/320,701, filed Apr. 11, 2016, by the present inventor and Brian R. Hamilton of Cranbury, N.J., and Chris A. Martin of Media, Pa.

### FEDERALLY SPONSORED RESEARCH

None

### CITED LITERATURE

SAE J-1772 Standard for Electric Vehicle Charging Equipment, Revised October 2012.

### PATENT CITATIONS

### High Level Control Systems

U.S. Pat. No. 9,948,101, Apr. 17, 2018, Chow et al. “Passive Peak Reduction Systems and Networks”, assigned to Green Charge Networks.
U.S. Pat. No. 10,007,259, Jun. 26, 2018, Turney et al, “Systems and Methods for Energy Cost Optimization in a Building System”, assigned to Johnson Controls.
see also U.S. Pat. Nos. 9,852,481, and 9,436,179 by the same inventor.
U.S. Pat. No. 10,137,796, Nov. 27, 2018, Huang et al “Control System for Electric Vehicle Charging Station and Method Thereof”, assigned to ABB.

also
U.S. Pat. No. 10,126,796, Nov. 13, 2018, Dorn & Malcolm
U.S. Pat. No. 9,783,068, Oct. 10, 2017, Eger, assigned to Siemens

### Stationary Inverters

U.S. Pat. No. 10,173,543, Jan. 8, 2019, Yang et al, “Charging System for Electric Vehicle and Method for Controlling Charging of Electric Vehicle” assigned to BYD automotive. Also
U.S. Pat. No. 10,166,882, Jan. 1, 2019, Yang et al
U.S. Pat. No. 10,166,877 Jan. 1, 2019, Zeng et al
U.S. Pat. No. 9,862,287 Jan. 9, 2018, Tang et al
U.S. Pat. No. 9,845,021 Dec. 19, 2017, Yang et al assigned to BYD
U.S. Pat. No. 9,821,669, Nov. 21, 2017, Tanabe, assigned to Panasonic

### On Board Inverter

U.S. Pat. No. 9,584,047, Feb. 28, 2017 Frohman, assigned to Engineered Electric Co.
   DC Charging from Stationary Converter

U.S. Pat. No. 9,481,259, Nov. 1, 2016, Choi et al, “Bidirectional Vehicle Charging Apparatus and Operating Method Therefore” assigned to Lisis Co, Ltd.

### BACKGROUND OF THE INVENTION

Commercial and Industrial electric service is typically billed in two major categories, Energy at so much per kilowatt hour (kWh) and Demand (Power) at so much per kiloWatt (kW). The logic of this is that producing the energy is costly in terms of variable costs of fuel and labor valued in terms of $ per kWh, while delivering the energy to the user is costly in terms of the fixed investment in power plants, transmission and distribution equipment, all of which is valued in terms of $/kW. Ultimately residential service, now usually billed solely in terms of $/kWh, may introduce demand charges because of the logic of the situation.

A feature of demand charging is that it penalizes peaks in demand, which is again logical because serving the demand requires equipment that can serve the peak, even if it is idle most of the time. Typically the demand charge is levied on the maximum demand over any 15-minute period in a monthly billing cycle. Some utilities increase the penalty by billing for the maximum over the following six to twelve months known as “ratcheting”.

Examples of loads that can produce peaks in demand are inductive loads such as air conditioners and other large motors that run intermittently. There are also major resistive loads such as electric furnaces, hot water heaters, and space heaters that operate intermittently. All of these loads by imposing a high demand for a short time, particularly those which are operative only occasionally, will cause an excessive demand charge relative to their actual energy consumption and usefulness, representing an inefficiency in the overall energy delivery system.

Demand charges incentivize anything that serves to level the load, reduce peaks and improve efficiency. Battery storage of electric energy can do this. A one kWh battery can spread a 15-minute load of 4 kW over an entire hour, thereby reducing the demand to 1 kW for a 75% saving in demand charge. The problem with battery storage is that it is expensive. The one kWh of capacity can cost anything up to $1000 to install.

Electric Vehicles (EV) s embody massive battery storage capability. The new generation of 200 mile range EVs typically have 60 kWh of capacity or more. If EVs can be utilized to provide electric energy storage at places of employment or residence during the time when load peaks are encountered, they can potentially level the load by bidirectional energy flow without affecting their range, life or utility as vehicles. It is an object of this invention to show how this may be done in an optimal manner. It is a further object of this invention to show how this may be done at minimum cost using only the existing equipment of the electric vehicle for resistive loads, which can be powered by DC electric energy. Success will provide the benefits of significant electric storage capability by the vehicle battery, an asset which is already paid for by virtue of serving another purpose, namely transportation.

### BRIEF SUMMARY OF THE INVENTION

The objectives of this invention are obtained by supplying electric energy to intermittent loads from the batteries of parked electric vehicles via a bidirectional (two way) electrical connection between the vehicle(s) and the load(s). In this way the vehicles can be recharged following use and simultaneously provide useful electric energy storage to level the load at the location where they are parked.

The energy to recharge the vehicle batteries is supplied by Alternating Current (AC) power from the grid through an Electric Vehicle Service Equipment (EVSE) to the onboard battery charger in the usual way. The load leveling energy is supplied to the load as Direct Current (DC) power either directly via the vehicle quick charge port or indirectly through the vehicle low voltage accessory battery system.

In the case of resistive loads such as heaters, if the voltage requirement of the heater matches the voltage available from the vehicle, or can be chosen to do so, the DC energy may be used directly, since resistance devices work equally well on DC or AC. This approach saves the cost of an inverter, and makes for a very simple and inexpensive solution.

### BRIEF DESCRIPTION OF THE DRAWINGS

FIG. 1 is a schematic diagram of the invention showing an Electric Vehicle connected to a building via a conventional AC EVSE for recharging and a DC connection via the vehicle's quick charge port and a circuit protection and control assembly to supply an intermittent load.

FIG. 1A shows the same apparatus with the addition of a stationary battery to provide power when the vehicle is not present.

FIG. 1B shows the internals of the circuit protection and control assembly in the DC connection to serve DC loads.

FIG. 1C shows the internals of the circuit protection and control assembly to serve AC loads.

FIG. 2 shows this invention with the DC connection made through the 12 V accessory battery of the electric vehicle thereby tapping the energy stored in the main propulsion battery indirectly through the onboard DC-DC converter.

### DETAILED DESCRIPTION OF THE INVENTION: THE PREFERRED EMBODIMENT

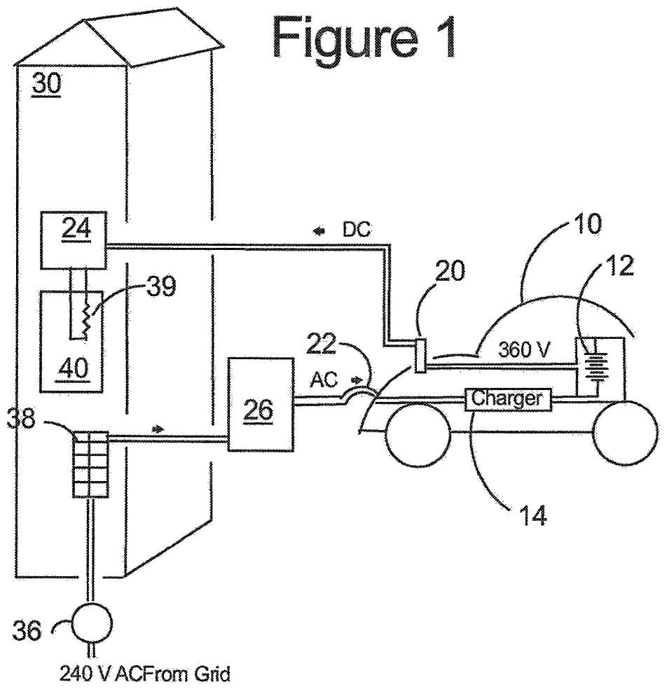

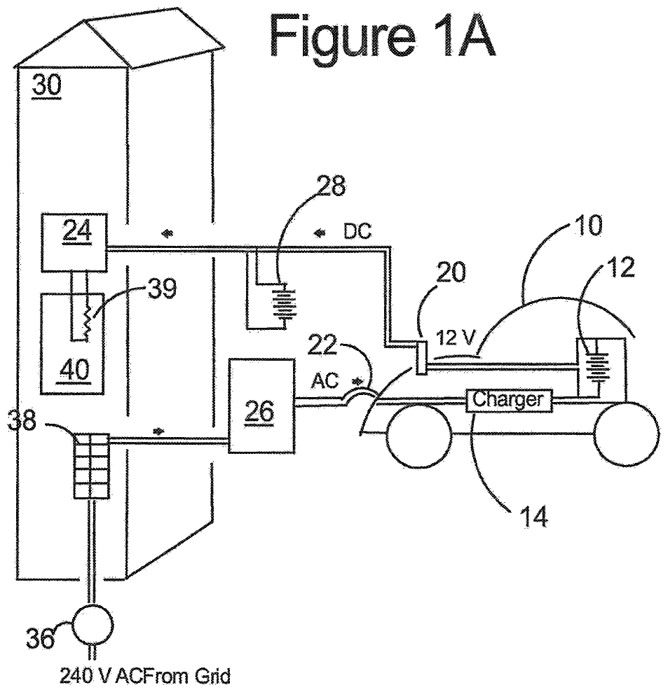

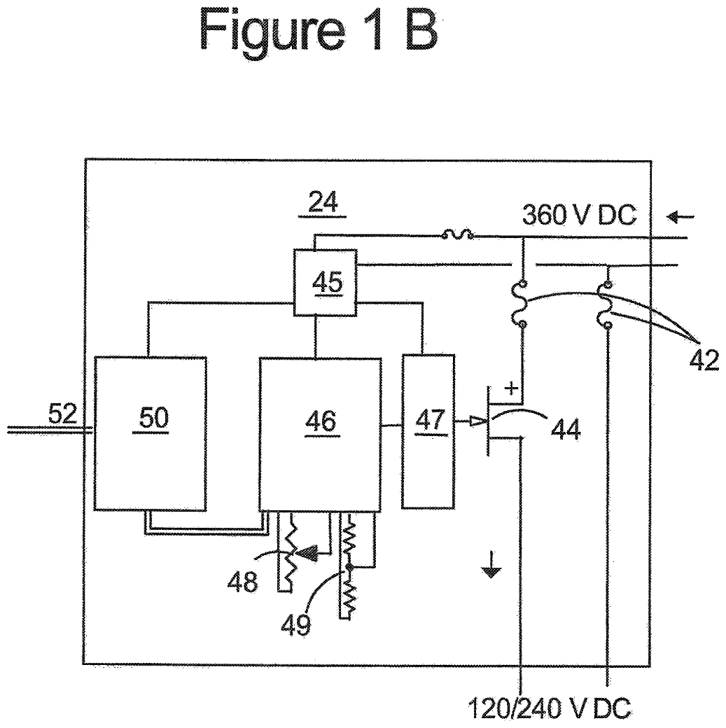

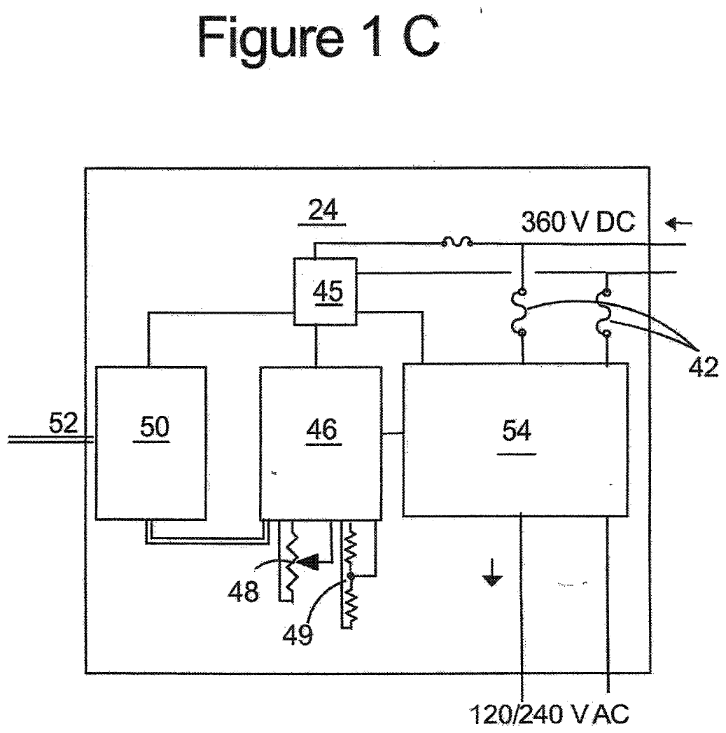

FIG. 1 shows an electric vehicle 10 with a main propulsion battery 12 having a capacity of 20-60 kWh at approximately 360V DC. Battery 12 is recharged by on-board charger 14 with AC energy from SAE J1772-compliant plug and receptacle 22 and Electric Vehicle Service Equipment 26. EVSE 26 receives its energy from distribution panel 38 connected to the electric grid through meter 36. The AC power flow for recharging is controlled by on-board charger 14 in the usual way to supply constant (maximum) current up to a high battery state of charge. The current is then reduced to complete the charge at constant voltage. There may be other steps programmed into 14 by the vehicle manufacturer. This invention does not modify or control the charging process, which proceeds as if the vehicle were otherwise unattached.

In applying this invention battery 12 additionally supplies DC electric energy through quick charge port 20, which will conform to standard DC quick charge protocols such as the Japanese CHAdeMO, US/European CCS or Tesla Supercharger standards. The DC electric energy flows through circuit protection and control assembly 24 to intermittent load 40 containing resistive heater 39. The electrical energy demand of load 40 is still controlled by its internal control, such as a thermostat, which is in series with the output of control assembly 24. The result is that the intermittent large demands of load 40 are supplied by a constant AC supply from panel 38 through EVSE 26 plug 22 and charger 14 with battery 12 acting to average the load and avoid costly peaks in demand for AC power.

For example if load 40 is a water heater in a commercial building with a capacity of 10 KW and during the eight hour day the building uses 10 gallons of hot water per hour, the heater will be on for fifteen minutes in every hour and with a typical demand charge of $10 per kW, the associated demand charge will be $100 per month. With 10 kWh of battery storage the average power can be reduced to a steady 2.5 kW for a monthly saving of $75. With 60 kWh of storage the entire 20 kWh load can be spread over 24 hours for an average power of 0.83 kW and a saving of $91.70 in demand charge. If in the example the heater is on all the time during the day and off at night a vehicle battery with a capacity of 60 kWh can still cut the demand charge by 66% provided that it is connected all day, recharged at night and run only morning and evening.

In FIG. 1A stationary battery 28 is added to the input of load 40 to provide energy when vehicle 10 is away from its recharging station. Battery 28 must be rated at the same voltage as battery 12, and ideally could be a used vehicle battery of the same type and voltage but less capacity because of age and prior use. Battery 28 is recharged in parallel with vehicle propulsion battery 12.

Additional intermittent loads may be connected in parallel with intermittent load 40. As many loads can be supplied as the vehicle battery and supplementary battery 28 can support. The power capability of the EV battery is over 100 KW and the quick charge port is rated at least at 50 kW. Over the course of a day the energy limit is imposed by the onboard charger, which has to make up the average of the intermittent load as well as the vehicle recharge requirement based on miles driven. Typical on board chargers are rated at 6.7 kW and above.

In FIG. 1B the internals of circuit protection and control assembly 24 are shown schematically. In the case where heater 39 is a DC heater with a voltage rating equal to the voltage of battery 12 or can be chosen to be so, control unit 24 may comprise only fuses 42 to provide circuit protection to the heater or other DC load. Fuses 42 may be any DC rated fuse such as UL rated Class CC fuses rated at 500 V DC and up to 30 Amps (10.8 kW at 360 V).

In cases where heater 39 cannot readily be matched to the voltage of battery 12, circuit and protection unit 24 contains control unit 46 which acts as a Pulse Width Modulated (PWM) generator to power semiconductor 44 which interrupts current in the DC circuit to lower its effective voltage below that of the vehicle battery voltage. Semiconductor switch 44 may be either a Power MOSFET or an Insulated Gate Bipolar Transistor (IGBT) such as the International Rectifier IRG4PC450 UD series rated at 600 V and 40 Amps. IGBTs are preferred in this slow switching, high voltage application.

Control unit 46 may be any eight-bit programmable controller with capabilities equivalent to an Arduino that can provide a PWM signal to turn on IGBT 44. The ATMEGA AVR series or the Microchip ADM series are suitable. A gate driver 47 to amplify the gate signal to 15 V such as the ZETEX ZXGD3005E6 will be needed. Energy from the DC circuit through fuse-protected power supply 45 will need to deliver 25 V to driver 47 and 5 V to controller 46 and to switch 50, if installed. Power supply 45 could be powered by 120 V AC from panel 38 or other means than the high voltage DC circuit shown. To match the EV battery voltage to the load requirement the PWM function will need to provide a pulse width equal to the ratio of either the 240 V or 120 V rating of heater 39 to the EV battery voltage. For example; Pulse width=240/360=67%.

The pulse width output on many controllers can be controlled by a variable resistive input to the controllers. Two such inputs are shown in FIG. 1B. Potentiometer 48 provides for an adjustable PWM output and effective DC voltage output from control assembly 24. Voltage divider 49 can provide a fixed PWM output with the individual resistors chosen so that R1 is proportional to 240 V and R1+R2 is proportional to EV battery voltage. Control unit 46 can supply several output drivers to support loads at different voltages if desired.

Control unit 46 can be programmed to operate load 40 at any time desired to provide for the needs of the building or to minimize demand during peak load hours. Controller 46 can also be controlled dynamically by communication device 50 in response to signals sent over connection 52. Control assembly 24 can cause load 40 to consume more energy at times of high availability and low cost and consume less in times of deficient capacity and high cost, in accordance with data made available over connection 52. Communication device 50 may be an Ethernet interface board compatible with controller 46 and connection 52 may be an Ethernet cable to a router, a WiFi antenna, or a cell phone receiver.

FIG. 1C shows the same apparatus configured to serve AC loads. IGBT drivers such as the ON Semiconductor STK5Q4U362J-E are available with six IGBTs embedded in them, which can put out three phase AC from a DC input. They can even improve on conventional inverters by providing variable frequency AC power to drive pumps and compressors more efficiently.

### OTHER EMBODIMENTS

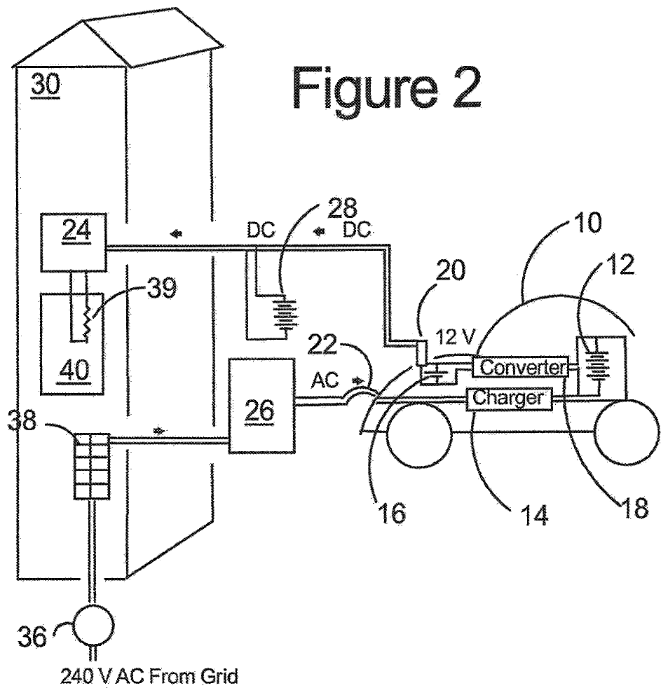

FIG. 2 is similar to FIG. 1A except that the DC connection is made through 12 V accessory battery 16 and DC-DC converter 18 of Vehicle 10. This approach provides a universal means of DC connection to any EV, but with the power from the vehicle limited to approximately one kW at 12 V. This may be acceptable if battery 28 can provide the power required by intermittent load 39 while the energy required is less than the 24 kWh per day that can be supplied via the accessory battery. Accessory battery voltages are slated to rise to as much as 48 V in future years.

Available vehicle battery storage provides a back up power source for the building in the event of a grid outage. Evaluating this is difficult but for many buildings, such as health care facilities, it is essential and must be provided in some fashion. Again, the fact that the vehicle battery is already paid for can provide major cost saving.

### PRIOR ART

The idea of battery storage to provide the various advantages listed above is by no means novel. There are recent US patents awarded for demand charge management. Chow and Turney cited above are primarily concerned with predicting demand and planning to meet it optimally, without specifying the methods or apparatus to do that.

There are a number of patents in which bidirectional energy flow from a vehicle is described, but many of them involve a stationary inverter to convert DC to AC as in Huang and Yang above. Frohman describes a similar system with the inverter on-board the vehicle and AC power flowing to and from the vehicle. Choi shows a similar system with a stationary converter and DC power flowing from and to the vehicle.

This invention discloses a specific method of connecting an electric vehicle to a building to utilize its battery for demand charge management and other purposes, and specific apparatus to do so. The unique features of his invention are believed to be:
1. Simultaneous connection to the vehicle via a preexisting J-1772 AC charging port and either a standard quick charge bidirectional DC port such a the Japanese CHAdeMO standard or the CCS US-European standard, or through the 12 V auxiliary battery system of the EV.
2. Provision of electric energy to a building as DC to operate voltage-matched resistive loads without the necessity for an inverter to provide AC power or a DC-DC converter to match voltage.
3. Extremely low cost power electronics to match DC voltage or to supply an AC load.

While the drawings and descriptions in this application are intended to be comprehensive, it will be understood by those skilled in the art that there are similar means to achieve the same ends, which fall within the claimed scope of this invention.

1. A method of leveling a load on an AC power grid comprising:
receiving energy at an Electric Vehicle Service Equipment (EVSE) from said AC power grid;
receiving said energy at an onboard battery charger of an electric vehicle from said EVSE;
receiving said energy at a battery of said electric vehicle from said onboard battery charger; and
receiving said energy at an intermittent external load from said battery of said electric vehicle as DC power through a quick charge port of said electric vehicle, whereby an instantaneous demand for electric power from said AC power grid is leveled, and whereby demand charges are therefore reduced as compared with supplying said intermittent external load directly from said AC power grid.

2. A method of leveling a load on an AC power grid as defined in claim 1, further comprising:
providing a stationary battery;
electrically coupling said stationary battery between said quick charge port of said electric vehicle and said intermittent external load; and
receiving said energy at said intermittent external load from said stationary battery during a time interval when said electric vehicle is unavailable.

3. A method of leveling a load on an AC power grid as defined in claim 1, wherein said receiving said energy from said battery of said electric vehicle at said intermittent external load comprises receiving pulse width modulated (PWM) power at said intermittent external load through a pulse width modulated (PWM) generator.

4. A method of leveling a load on an AC power grid as defined in claim 1, further comprising:
providing a circuit protection and control assembly;
electrically coupling said circuit protection and control assembly between said quick charge port of said electric vehicle and said intermittent external load; and
providing circuit protection to said intermittent external load.

5. A method of leveling a load on an AC power grid as defined in claim 1, wherein said intermittent external load comprises a resistive load.

6. A method of leveling a load on an AC power grid as defined in claim 1, wherein an electrical energy demand of said intermittent external load is controlled by an internal control of said intermittent external load.

7. A method of leveling a load on an AC power grid comprising:
receiving energy at an Electric Vehicle Service Equipment (EVSE) from said AC power grid;
receiving said energy at an onboard battery charger of an electric vehicle from said EVSE;
receiving said energy at a battery of said electric vehicle from said onboard battery charger; and
receiving said energy at an intermittent external load from said battery of said electric vehicle as DC power through a low voltage accessory battery system of said electric vehicle, whereby instantaneous demand for electric power from said AC power grid is leveled, and whereby demand charges are therefore reduced as compared with supplying said intermittent external load directly from said AC power grid.

8. A method of leveling a load on an AC power grid as defined in claim 7, further comprising:
providing a stationary battery;
electrically coupling said stationary battery between said low voltage accessory battery system of said electric vehicle and said intermittent external load; and
receiving said energy at said intermittent external load from said stationary battery during a time interval when said electric vehicle is unavailable.

9. A method of leveling a load on an AC power grid as defined in claim 7, wherein said receiving load leveling energy from said battery of said electric vehicle at said intermittent external load comprises receiving pulse width modulated (PWM) power at said intermittent external load through a pulse width modulated (PWM) generator.

10. A method of leveling a load on an AC power grid as defined in claim 7, further comprising:
providing a circuit protection and control assembly;
electrically coupling said circuit protection and control assembly between said low voltage accessory battery system of said electric vehicle and said intermittent external load; and
providing circuit protection to said intermittent external load.

11. A method of leveling a load on an AC power grid and simultaneously recharging an electric vehicle comprising:
providing an Electric Vehicle Service Equipment (EVSE);
electrically coupling said EVSE to said AC power grid;
providing said electric vehicle;
electrically coupling said electric vehicle to said EVSE to recharge a battery of said electric vehicle through an onboard battery charger of said electric vehicle;
providing an intermittent external load; and
simultaneously with said recharging said battery of said electric vehicle, receiving load leveling energy from said battery of said electric vehicle at said intermittent external load so as to avoid costly peaks in demand for AC power from said AC power grid.

12. A method of leveling a load on an AC power grid and simultaneously recharging an electric vehicle as defined in claim 11, wherein said receiving load leveling energy from said battery of said electric vehicle at said intermittent external load comprises receiving DC current directly via a quick charge port of said electric vehicle.

13. A method of leveling a load on an AC power grid and simultaneously recharging an electric vehicle as defined in claim 11, wherein said receiving load leveling energy from said battery of said electric vehicle at said intermittent external load comprises receiving DC current directly via a low voltage accessory battery system of said electric vehicle.

14. A method of leveling a load on an AC power grid and simultaneously recharging an electric vehicle as defined in claim 11, wherein said receiving load leveling energy from said battery of said electric vehicle at said intermittent external load comprises receiving pulse width modulated (PWM) power at said intermittent external load through a pulse width modulated (PWM) generator.

15. A method of leveling a load on an AC power grid and simultaneously recharging an electric vehicle as defined in claim 11, further comprising:
providing a circuit protection and control assembly;
electrically coupling said circuit protection and control assembly between said battery of said electric vehicle and said intermittent external load; and
providing circuit protection to said intermittent external load.

16. A method of leveling a load on an AC power grid and simultaneously recharging an electric vehicle as defined in claim 11, wherein said intermittent external load comprises a resistive load.

17. A method of leveling a load on an AC power grid and simultaneously recharging an electric vehicle as defined in claim 16, wherein said resistive load is a heater.

18. A method of leveling a load on an AC power grid and simultaneously recharging an electric vehicle as defined in claim 17, wherein said heater is a commercial water heater.

19. A method of leveling a load on an AC power grid and simultaneously recharging an electric vehicle as defined in claim 11, wherein an electrical energy demand of said intermittent external load is controlled by an internal control of said intermittent external load.

20. A method of leveling a load on an AC power grid and simultaneously recharging an electric vehicle as defined in claim 19, wherein said internal control of said intermittent external load comprises a thermostat.
